(19) United States
(12) Patent Application Publication
(10) Pub. No.: US 2003/0012909 A1
(43) Pub. Date: Jan. 16, 2003

(54) Double-layer pipe

(76) Inventor: Stephane Jung, Vitry-Le-Francois (FR)

Correspondence Address: YOUNG & THOMPSON, 745 SOUTH 23RD STREET 2ND FLOOR, ARLINGTON, VA, 22202

(21) Appl. No.: 10/220,631

(22) PCT Filed: Mar. 6, 2001
(86) PCT No.: PCT/FR01/00648

(51) Int. Cl. B32B 1/08

(52) U.S. Cl. 428/36.91

(57) ABSTRACT

The invention concerns a double-layer pipe comprising an inner polyamide based layer and an outer layer based on one of the following polymers: polyether ester, polyester ether, fluorinated polymer.

The present invention relates to a pipe for transporting fluid. By way of example the pipe can be installed in a control circuit for a clutch, a brake, or power-assisted steering in a motor vehicle.

In essence, a hydraulic clutch control system generally comprises an actuator pedal, a control liquid emitter connected to the actuator pedal, a control liquid receiver connected to clutch itself, and a linking pipe connected to the emitter and to the receiver for the purpose of transporting the control liquid between them. Action on the control pedal causes an emitter piston to move and urge the liquid towards the receiver, thereby causing a receiver piston to move and operate the clutch.

The link pipe needs to satisfy various requirements in order to ensure that clutch control operates properly. Thus, the pipe must retain an inside volume that is constant over temperatures lying in the range −400° C. to +150° C. and for pressures lying in the range 10 bars to 40 bars so as to ensure that a determined displacement of the pedal gives rise to a corresponding displacement of the receiver piston that remains substantially constant regardless of temperature and pressure conditions. The pipe must also possess bursting strength capable of withstanding a pressure of about 200 bars and must conserve flexibility down to a temperature of about −50° C.

Amongst other conditions that the pipe needs to satisfy, the following are particularly important: impermeability to water (to ensure that no water becomes mixed with the control liquid which would lower its boiling temperature); ability to withstand occasional contact with fluids such as battery acid in vapor form, oil, and saline solutions for clearing snow (such as zinc chloride); and resistance to thermomechanical aging (caused by sudden variations of pressure at different temperatures).

At present, the pipes generally used are in the form of a metal tube associated with a braided rubber hose. Nevertheless, such pipes are relatively expensive (in particular because of the need to assemble together the two component elements thereof, which also complicates quality inspection operations on the pipe). In addition, the hose is permeable to water which runs the risk of leading to corrosion of the metal tube. Finally, such pipes are relatively heavy, which goes against the present trend of reducing weight as far as possible in motor vehicles.

An object of the invention is to provide a pipe that satisfies the above-specified conditions while remedying the above-mentioned drawbacks.

To achieve this object, the invention provides a two-layer pipe comprising an inner layer and an outer layer, the inner layer being based on polyamide and the outer layer being based on at least one of the following polymers:

polyether ester;

polyester ether; and

fluoropolymer.

Thus, the polyamide inner layer prevents the pipe from deforming under the effect of pressure and/or temperature and it withstands the transported fluid. This inner layer also gives the pipe good resistance to other mechanical stresses.

The polyamide used for making the inner layer is advantageously a 6-6 polyamide.

The function of the outer layer is to constitute a layer forming a barrier against water and to protect the inner layer from coming into contact with the fluids present in the environment outside the pipe (battery acid vapor, oil and other hydrocarbons, saline solutions for clearing snow, . . . ).

The fluoropolymer can be constituted for example by polyvinylidene difluoride (PVDF) or by a tetrafluoroethylene hexafluoropropylene vinylidene fluoride (THV, such as that sold by the supplier Dyneon). As polyester ether, use can be made for example of the substance sold by the supplier DSM under the trademark Arnitel or by the supplier DuPont de Nemours under the trademark Hytrel.

By way of example, the pipe is made by coextruding the materials constituting the inner and outer layers.

The pipe made in accordance with the invention constitutes a satisfactory compromise between all of the above-mentioned requirements.

It also possesses good flexibility making it easier to install in the engine compartment and leaving it free to move in operation.

The inner layer is of a thickness that preferably lies in the range substantially 80% to 90% of the total thickness of the pipe.

For the intended applications, such a structure gives the pipe optimum characteristics (in terms of mechanical strength, resistance to chemical attack, flexibility, impermeability, lifetime, . . . ).

For example, for an inside diameter lying in the range 3.5 millimeters (mm) to 4 mm, the pipe will have an outside diameter lying in the range 7 mm to 8 mm.

Naturally, the invention is not limited to the embodiments described and variants can be applied thereto without going beyond the ambit of the invention as defined by the claims.

In particular, applications other than those mentioned above can be envisaged for the pipe of the invention.

In addition, the numerical values given are given purely by way of indication and the pipe may be given other dimensions in order to satisfy particular conditions of use (for example as a function of the quantity of fluid it is to receive, working pressures, utilization temperatures, . . . ).

1/ A two-layer pipe comprising an inner layer and an outer layer, the pipe being characterized in that the inner layer is based on polyamide and in that the outer layer is based on at least one of the following polymers:
polyether ester;
polyester ether; and
fluoropolymer.

2/ A pipe according to claim 1, characterized in that the inner layer has a thickness substantially in the range 80% to 90% of the total thickness of the pipe.

3/ A pipe according to claim 1 or claim 2, characterized in that for an inside diameter lying in the range 3.5 mm to 4 mm, the pipe has an outside diameter lying in the range 7 mm to 8 mm.

4/ A pipe according to any one of claims 1 to 3, characterized in that the inner layer is made of 6-6 polyamide.
